(19) United States
(12) Patent Application Publication
(10) Pub. No.: US 2019/0128323 A1
(43) Pub. Date: May 2, 2019

(54) CLOSURE PANEL EXTENSION MECHANISM WITH BUSHINGS

(71) Applicant: Magna Closures Inc., Newmarket (CA)

(72) Inventors: Joseph SCHEURING, Richmond Hill (CA); Wieslaw NOWICKI, Mississauga (CA)

(21) Appl. No.: 16/176,710

(22) Filed: Oct. 31, 2018

Related U.S. Application Data
(60) Provisional application No. 62/580,560, filed on Nov. 2, 2017.

(51) Int. Cl. F16C 29/12; E05F 1/10; F16C 29/02; F16C 33/20; F16C 35/02; F16F 1/02

(52) U.S. Cl. CPC F16C 29/12; E05F 1/105; F16C 29/02; F16C 33/20; F16C 35/02; F16C 2204/60; E05Y 2201/474; E05Y 2201/628; E05Y 2201/624; E05Y 2800/28; E05Y 2900/532; F16F 1/025

(57) ABSTRACT

A extension mechanism for coupling with a closure panel to assist in opening and closing of the closure panel for at least a portion of a path including a housing member, an extension member and one or more bushings for positioning the extension member within the housing member. The bushings can provide friction for assisting in hold positions of the extension mechanism. The extension mechanism can be incorporated as part of a biasing strut such as a spring configured strut.

### CROSS-REFERENCE TO RELATED APPLICATIONS

This application claims priority from U.S. Provisional Patent Application No. 62/580,560, filed on Nov. 2, 2017; the entire contents of which are hereby incorporated by reference herein.

### FIELD

This disclosure relates to an extension mechanism for a closure panel.

### BACKGROUND

Some vehicles are equipped with a closure panel, such as a lift gate, which is driven between an open position (position 2) and a closed position (position 1) using an electric drive system. Hold systems have been proposed to provide such vehicles with the capability of assisting the operator of the closure panel, in order to maintain a third position hold (or position 2) during opening and closing operations, so as to help counteract the weight of the closure panel itself. Without these hold systems, the closure panel may sag back down at the top end of the operational opening range due to the closure panel weight providing a closure torque greater than an opening torque provided by the electric drive system. Such proposed hold systems are, in some instances, complex and expensive and may not offer adequate failsafe modes (in the event of electric motor failure or loss of power) while at the same time maintaining adequate manual efforts by the operator.

Further disadvantages of current hold systems include bulky form factors which take up valuable vehicle cargo space, requirement to have additional lift support systems in tandem such as gas struts and other counterbalance mechanisms, unacceptable impact on manual open and close efforts requiring larger operator applied manual force at the panel handle, undesirable force spikes that do not provide for smoother manual force/torque curves, requirement to use vehicle battery power to maintain third position hold, and/or temperature effects resulting in variable manual efforts required by the operator due to fluctuations in ambient temperature.

It is recognized that constantly applied forces in a counterbalance mechanism can be problematic due to variations in the geometry and/or operator positioning during the complete raise and lowering cycle of a closure panel, including the ability to provide for third position hold where desired.

Further, actuators and counterbalance mechanisms for vehicle liftgates are typically telescoping tube embodiments that require bushings for the control of lateral movement to keep the tubes concentric while moving linearly and/or rotating relative to one another. These bushings require minimal clearance for assembly and thermal expansion. These bushings can also wear throughout the life of the product, resulting in increased side-to-side (i.e. lateral) movement, reduced concentricity and impacted/decreased friction hold potential.

### SUMMARY

It is an object of the present invention to provide an extension mechanism that obviates or mitigates at least one of the above presented disadvantages.

It is another objective to provide an extension mechanism that improves radial alignment and tolerance stack for telescoping tubes, and counterbalances, or the like.

It is another objective to provide an extension mechanism that provides additional friction throughout the travel of the extension mechanism for improved stop and hold functionality, as well as customizable friction modularity based on the desired amount of friction of a closure panel application.

It is another objective to provide an extension mechanism that provides such above mentioned advantages without any impact on cost and packaging space of the extension mechanism.

It is another objective to provide an extension mechanism that has improved creep resistance and thermal stability, and which minimizes loss of friction force due to relaxation in prolonged heat exposure.

One aspect provided is an extension mechanism for coupling with a closure panel of a vehicle to assist in opening and closing of the closure panel between a fully closed position and a fully open position of the closure panel, the extension mechanism including: a housing member having an interior; a lead screw positioned in the housing member along a longitudinal axis, the lead screw operatively coupled to a travel member; an extension member positioned in the housing member along the longitudinal axis and having an inner surface between a distal member portion and proximal member portion, the extension member connected to the travel member at the proximal member portion for assisting in extension and retraction of the extension member with respect to the housing member as the lead screw rotates; and a bushing connected to a distal screw portion of the lead screw such that the bushing is positioned between the distal member portion and the proximal member portion, the bushing having one or more projections extending laterally outwards with respect to the longitudinal axis and biased via one or more resilient elements into frictional contact with the inner surface.

A further aspect provided is an extension mechanism for coupling with a closure panel of a vehicle to assist in opening and closing of the closure panel between a fully closed position and a fully open position of the closure panel, the extension mechanism including: a housing member defining a longitudinal axis and having an interior surface between a distal housing portion and a proximal housing portion; an extension member positioned in the housing member along the longitudinal axis, the extension member configured for extension and retraction with respect to the housing member; and a bushing connected to a proximal member portion of the extension member such that the bushing is positioned between the distal housing portion and the proximal housing portion, the bushing having one or morea plurality of projections extending laterally outwards with respect to the longitudinal axis and biased via one or more resilient elements into frictional contact with the interior surface.

In accordance with another aspect, there is provided a bushing for an extension mechanism for coupling with a closure panel of a vehicle to assist in opening and closing of the closure panel, the extension mechanism including a housing member defining a longitudinal axis, and an extension member positioned at least partially in the housing member along the longitudinal axis, the extension member configured for extension and retraction with respect to the housing member, the bushing including a peripheral outer member having an outside surface for frictionally engaging with one of the housing and the extension member, a peripheral inner member spaced apart radially from the peripheral outer member and having an inner surface for operably connecting with the other one of the housing and the extension member, and one or more resilient elements positioned between the peripheral outer member and the peripheral inner member for biasing the peripheral outer member away from the peripheral inner member to frictionally engage the outside surface with the one of the housing and the extension member.

In accordance with another aspect, there is provided a method of concentrically aligning a housing and an extension member of an extension mechanism for coupling with a closure panel of a vehicle to assist in opening and closing of the closure panel, the housing and the extension member configured to telescope relative to one another, the method including the steps of connecting a peripheral outer member to one of the housing and the extension member, frictionally engaging an inner peripheral member spaced apart radially from the peripheral outer member to the other one of the housing and the extension member, and biasing the peripheral outer member away from the peripheral inner member using one or more resilient elements to frictionally engage the other one of the housing and the extension member.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a side view of a vehicle with a closure panel assembly;

FIG. 2 is an alternative embodiment of the vehicle of FIG. 1;

FIG. 3a,b,c,d show different embodiments of a bushing of an extension mechanism in FIG. 1;

FIG. 4 is an exploded view of an example biasing strut of FIG. 1;

FIG. 5 shows an alternative embodiment of the vehicle with a closure panel assembly of FIG. 1;

FIG. 6 shows an alternative embodiment of the biasing strut of FIG. 4;

FIG. 7a shows a cross sectional view of the biasing strut of FIG. 4;

FIG. 7b shows a cross sectional view of the biasing strut of FIG. 6;

FIG. 7c shows a cross sectional view of the biasing strut of FIG. 6, in accordance with an illustrative example; and

FIG. 8 shows a method of concentrically aligning a housing and an extension member of an extension mechanism, in accordance with an illustrative embodiment.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

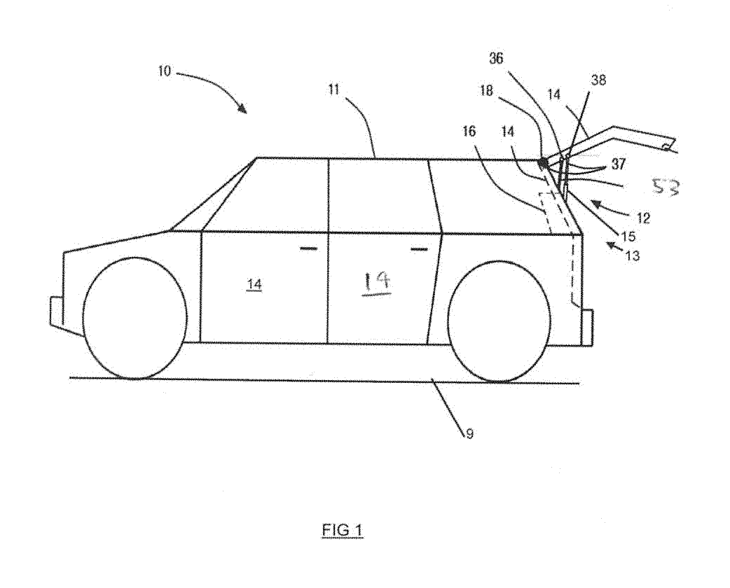

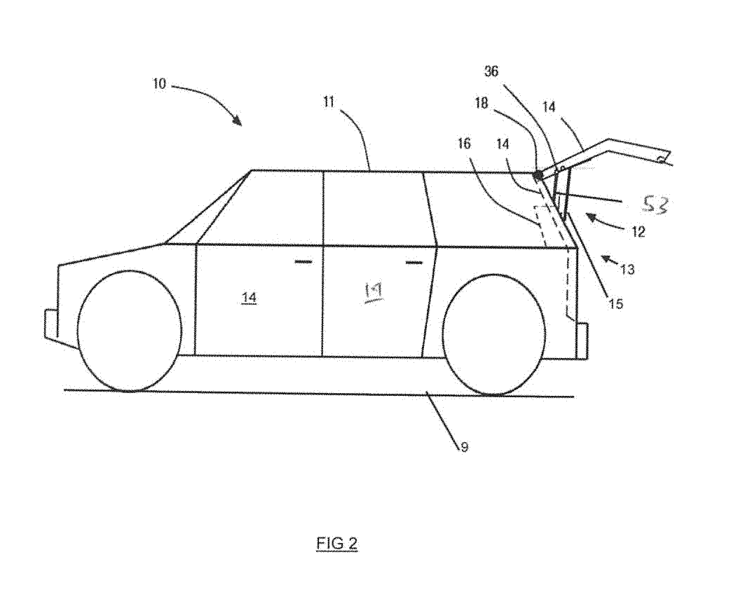

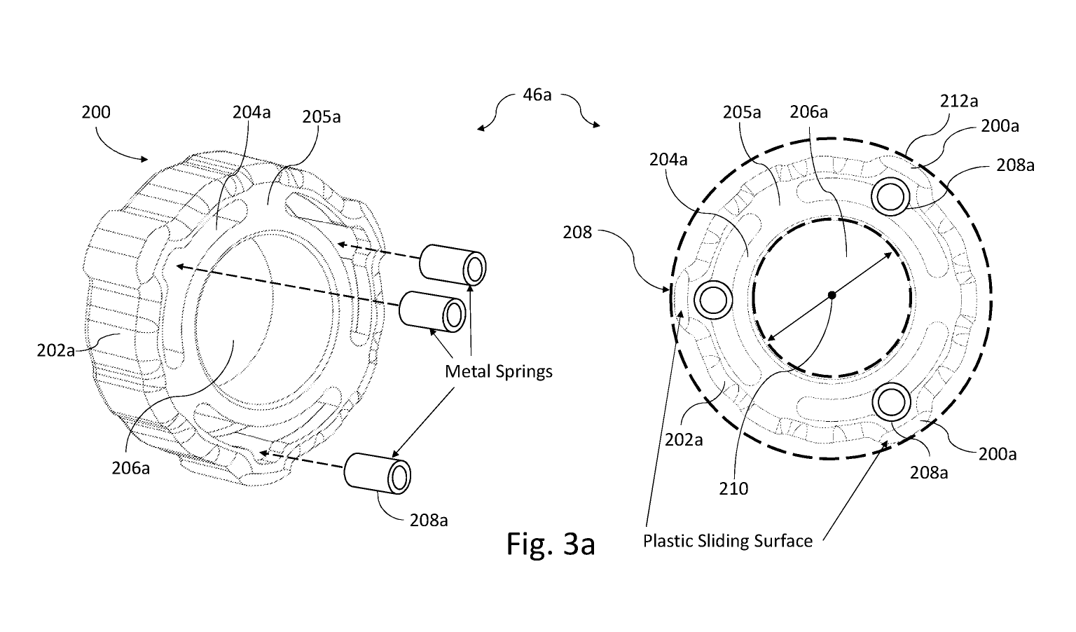

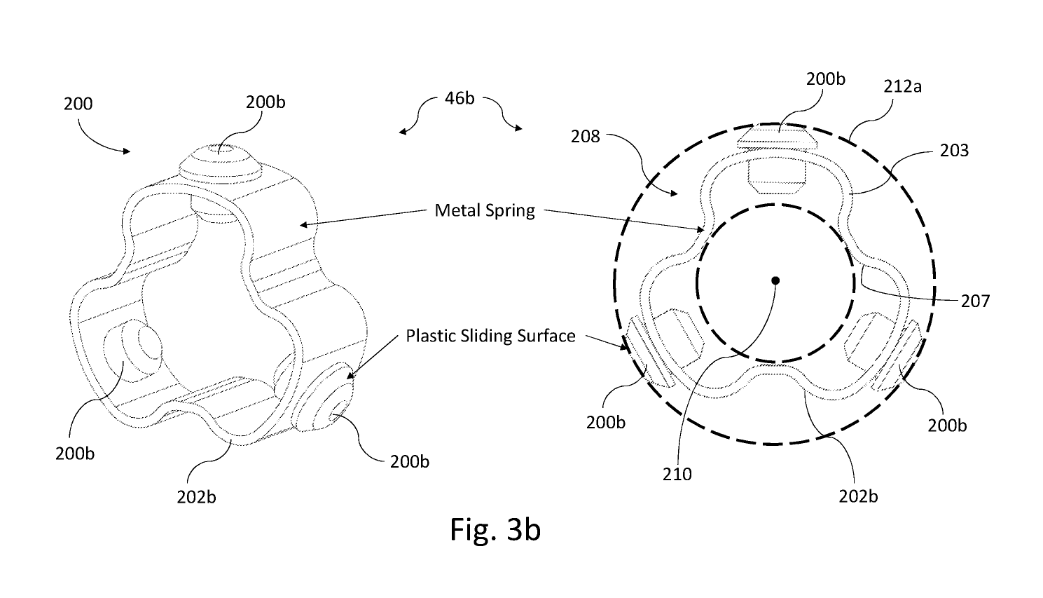

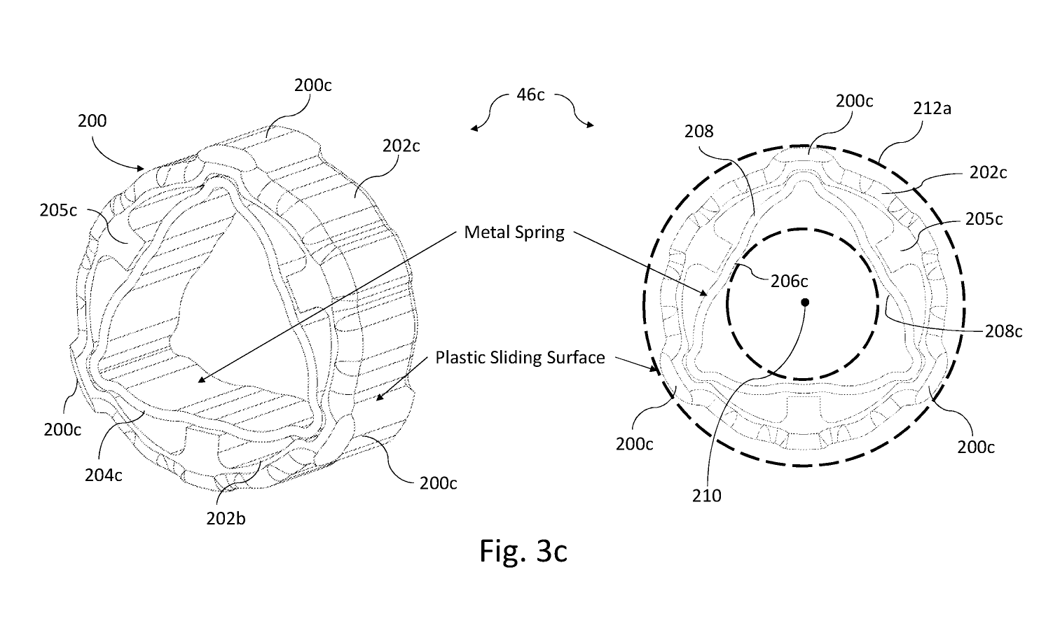

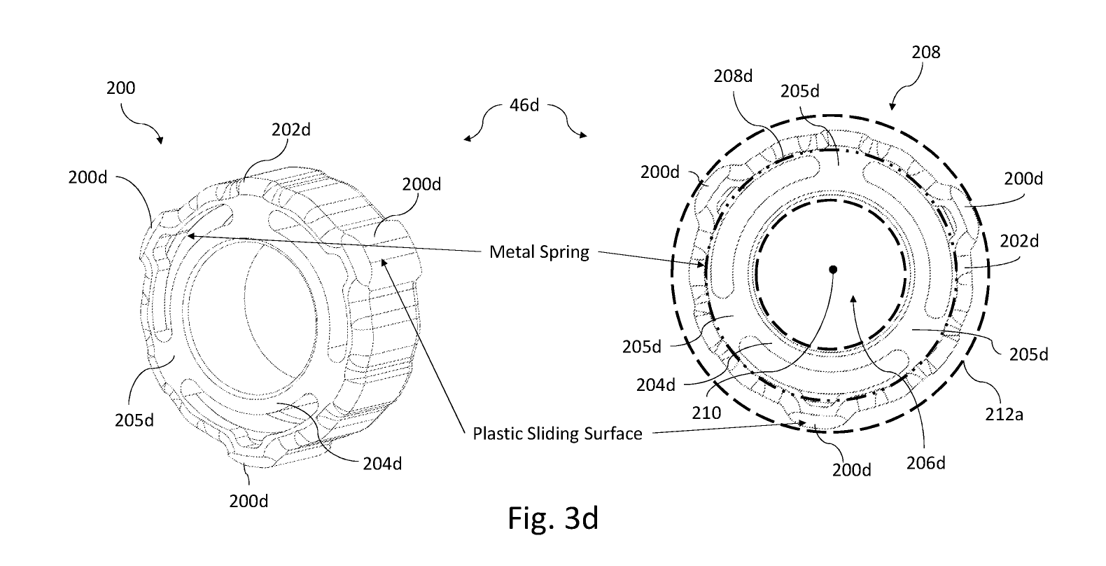

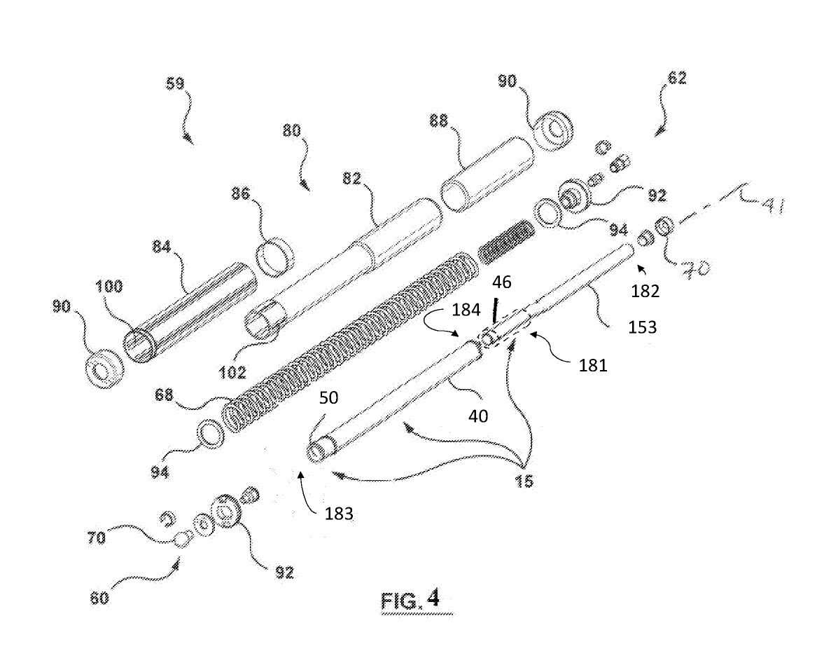

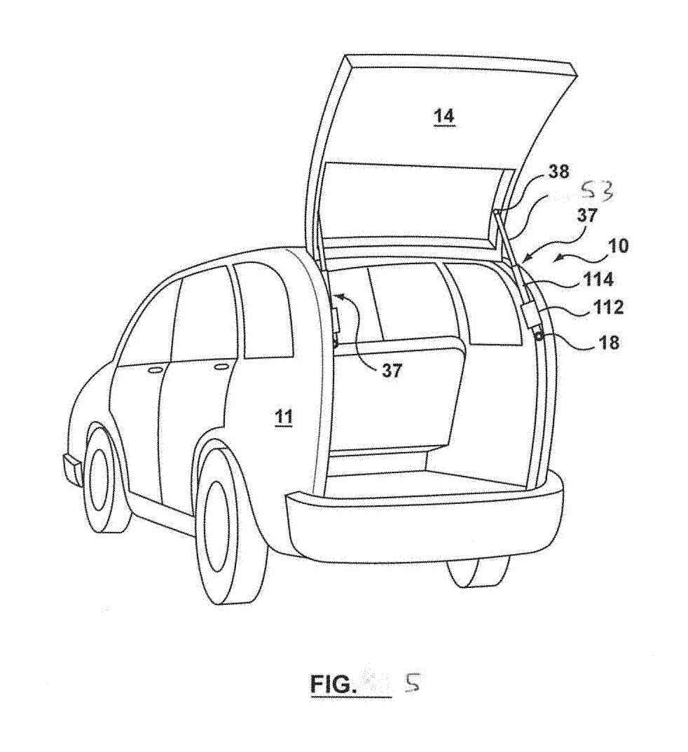

Provided is an actuator or extension mechanism 15 (e.g. counterbalance mechanism—see FIG. 1) that can be used advantageously with vehicle closure panels 14 to provide for open and close fail safe modes in the event of power actuator failure or disconnection and/or to provide for operator assistance, as discussed below, in particular for land-based, sea-based and/or air-based vehicles 10. Other applications of the extension mechanism 15, in general for closure panels 14 both in and outside of vehicle applications, include advantageously assisting in optimization of overall hold and manual effort forces for closure panel 14 operation. It is recognized as well that the extension mechanism 15 examples provided below can be used advantageously as the sole means of open and close assistance for closure panels 14 or can be used in combination (e.g. in tandem) with other closure panel 14 biasing members (e.g. spring loaded hinges, biasing struts, etc.). In particular, the extension mechanism can be friction assisted via one or more bushings 46 (see FIGS. 3a,b,c,d and 4) and used to provide or otherwise assist in a holding force (or torque) for the closure panel 14, as further described below. Further, it is recognized that the extension mechanism can be integrated with a biasing member 37 (see FIG. 1) such as a spring loaded strut and/or provided as a component of a closure panel assembly, as further described below. It is recognized that the biasing member 37, incorporating the extension mechanism 15, can be implemented as a strut (see FIGS. 4 and 6 as example types of struts). The strut can be of a biasing type (e.g. spring and/or gas charge supplying the bias), can include a drive unit for example with a lead screw 140 (see FIG. 6) and/or as a counterbalance embodiment (see FIG. 4). The strut can be of an electromechanical type (e.g. driven by an optional integrated motor assembly with spring and/or gas charge supplying a bias), as desired.

Referring to FIG. 1, shown is the vehicle 10 with a vehicle body 11 having one or more closure panels 14. One example configuration of the closure panel 14 is a closure panel assembly 12 including an extension mechanism 15 (e.g. incorporated in a biasing member 37 embodied as a strut by example) and a closure panel drive system 16 (e.g. incorporating an electrically powered motor/drive). For vehicles 10, the closure panel 14 can be referred to as a partition or door, typically hinged, but sometimes attached by other mechanisms such as tracks, in front of an opening 13 which is used for entering and exiting the vehicle 10 interior by people and/or cargo. It is also recognized that the closure panel 14 can be used as an access panel for vehicle 10 systems such as engine compartments and also for traditional trunk compartments of automotive type vehicles 10. The closure panel 14 can be opened to provide access to the opening 13, or closed to secure or otherwise restrict access to the opening 13. It is also recognized that there can be one or more intermediate hold positions of the closure panel 14 (assisted via the bushings 46) between a fully open position and fully closed position, as provided at least in part by the extension mechanism 15 as further described below. For example, the extension mechanism 15 can assist in biasing movement of the closure panel 14 away from one or more intermediate hold position(s), also known as Third Position Hold(s) (TPHs) or Stop-N-Hold(s), once positioned therein. It is also recognized that the extension mechanism 15 can be provided as a component of the closure panel assembly 12, such that the extension mechanism 15 component can be separate from the one or more biasing struts 37.

### Extension Mechanism 15 Functionality

The closure panel 14 can be opened manually and/or powered electronically via the closure panel drive system 16, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14. The force assisted open and close mechanism(s) can be provided by the extension mechanism 15, any biasing members 37 (e.g. spring loaded hinges, spring loaded struts, gas loaded struts, electromechanical struts, etc.) and the closure panel drive system 16 when used as part of the closure panel assembly 12, such that the extension mechanism 15 is configured to provide a friction based holding torque (or force) that acts against the weight of the closure panel 14 on at least a portion of the panel open/close path about the third position hold, in order to help maintain the position of the closure panel 14 about the third position hold. The ability to provide the desired hold friction within the extension mechanism is facilitated by one or more of the bushings 46 (see FIGS. 3a,b,c,d).

It is recognized that an electromechanical strut version of the extension mechanism 15 can have a lead screw 140 (see FIG. 6) operated either actively (i.e. driven) by a motor 142 (e.g. electrical) or operated passively such that the lead screw is free to rotate about its longitudinal axis but is not actively driven by a motor 142. It is recognized that a travel member 45 (see FIG. 6) can be coupled to the lead screw 140, e.g. via a threaded connection) such that the travel member 45 is also connected to a shaft 53 (e.g. solid or hollow) connected to the closure panel 14. It is the travel member 45, via actuation by the lead screw 140, that drives the shaft 53 (also referred to as extension member) extension and retraction with respect to a housing member 40 of the extension mechanism 15. It is the role of the bushing 46, as further described below, and not the travel member 45, to provide for the maintenance of appropriate spacing and/or positioning between the lead screw 140 and shaft 53 or the shaft 53 and other longitudinal components (e.g. housing member 40) of the extension mechanism 15. Preferably the travel member 45 is spaced apart from an interior surface 50 of the housing member 40 and thus not in contact therewith. The interior surface 50 is positioned between a distal housing portion 184 and a proximal housing portion 183. In an embodiment, it is the role of the bushing 46, as further described below, to provide for the maintenance of appropriate concentric spacing and/or positioning between an first telescopic member (e.g. extension member 53), such as a first tubular telescopic member, and a second telescopic member (e.g. housing 40, or shaft 140′ or lead screw 140), such as a second tubular telescopic member, being of smaller or larger diameter than the first telescopic member, the first telescopic member and the second telescopic member provided in at least partially overlapping configuration during extension and/or retraction relative to one another. It is the role of the bushing 46, as further described below, to provide for the generation of friction between the first telescopic member and a second telescopic member.

It is recognized that the extension mechanism 15 can be configured as an independent counterbalance mechanism for the closure panel 14 and/or can be configured as a component of a biasing member 37 (e.g. incorporated as an internal component of a strut).

### Closure Panel Assembly 12 Configuration

In terms of vehicles 10, the closure panel 14 may be a lift gate as shown in FIG. 1, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 11 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 1, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18, which is preferably configured as horizontal or otherwise parallel to a support surface 9 of the vehicle 10. In other embodiments, the pivot axis 18 may have some other orientation such as vertical or otherwise extending at an angle outwards from the support surface 9 of the vehicle 10. In still other embodiments, the closure panel 14 may move in a manner other than pivoting, for example, the closure panel 14 may translate along a predefined track or may undergo a combination of translation and rotation between the open and closed position.

Referring again to FIG. 1, as discussed above, the extension mechanism 15 examples provided below for the closure panel assembly 12 can be used as the sole means of open and close assistance for the inhibition of sag by the closure panels 14 themselves (see FIG. 2), or can be used in combination (e.g. in tandem or otherwise integrated) with one or more other closure panel biasing members 37 (e.g. spring loaded hinges, struts such as gas struts or spring loaded struts, etc.) that provide a primary connection of the closure panel 14 to the vehicle body 11 at a pivot connection 18,38 (see FIG. 1). In general operation of the closure panel 14, the closure panel drive system 16 can be coupled to a distal end of the shaft 53 used to connect the closure panel 14 as a secondary connection of the closure panel to the vehicle body 11, such that the closure panel biasing member 37 and the shaft 53 can be pivotally attached to the closure panel 14 at spaced apart locations as shown. In this manner, the other end (e.g. proximal end) of the shaft 53 pivotally can connect to the closure panel 14 at pivot connection 36. It is recognized that the shaft 53 itself can be configured as a non-biasing element (e.g. a solid/hollow rod) or can be configured as part of a biasing element (e.g. a gas or spring assisted extension strut), as desired.

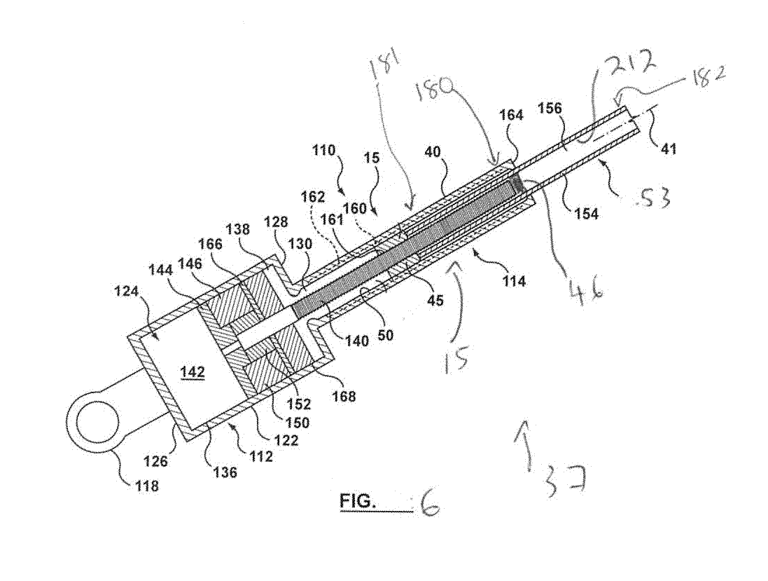

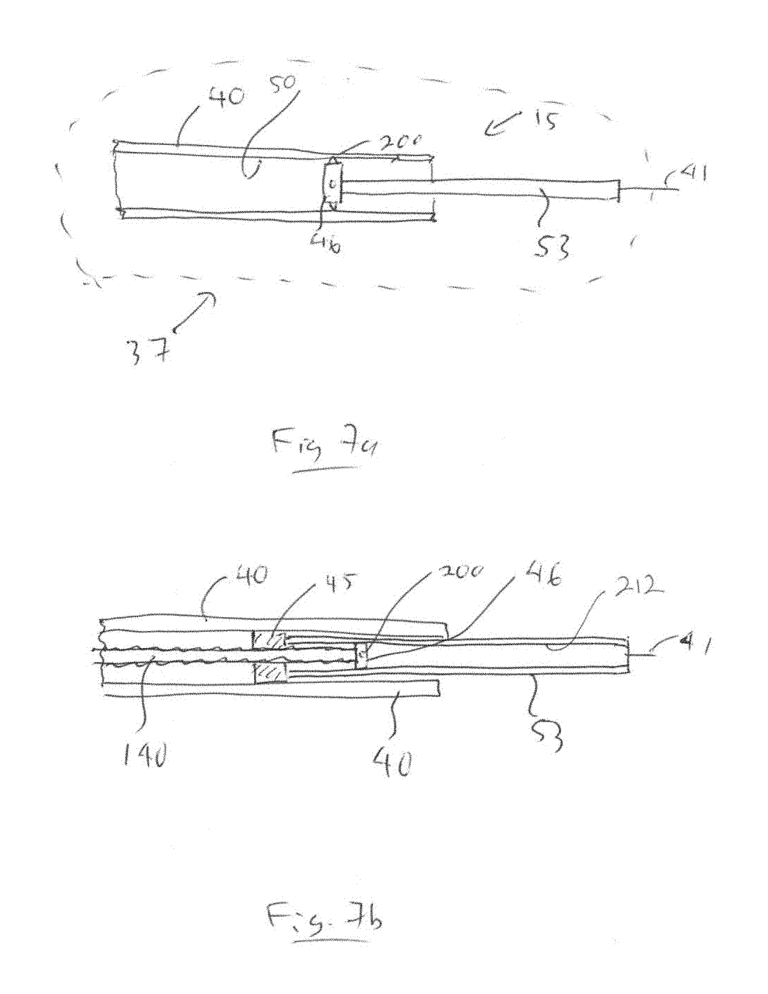

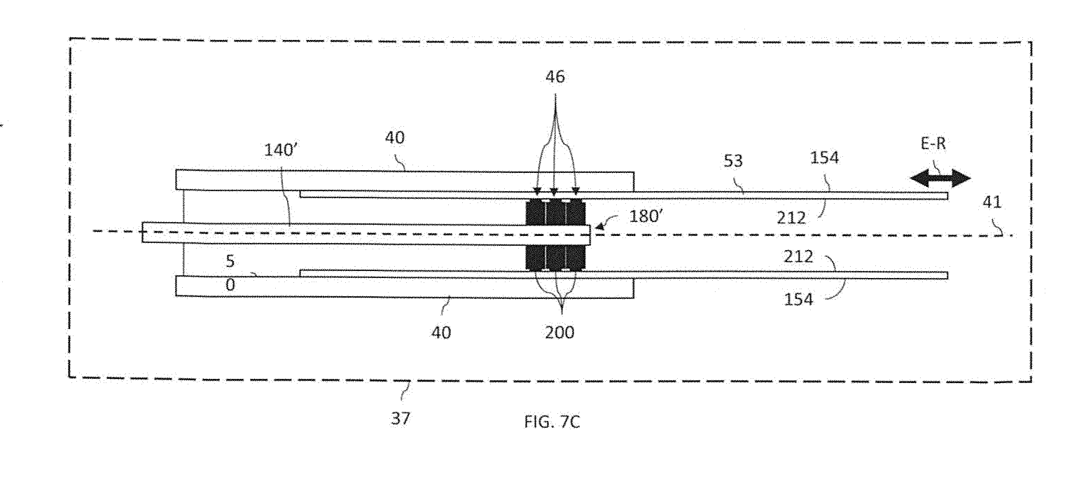

Referring again to FIG. 1, one or more optional closure panel biasing members 37 can be provided which urge the closure panel 14 towards the open position throughout at least some portion of the path between the open position and the closed position and which assist in holding the closure panel 14 in the open position (assisted via the bushings 46). The closure panel biasing members 37 can be, for example, gas extension struts which are pivotally connected at their proximal end to the closure panel 14 and at their distal end to the vehicle body 11. In the embodiment shown, there are two biasing members 37 (one on the left side of the vehicle 10 and one on the right side of the vehicle 10), however one biasing member 37 is obscured by the other in the view shown. 10. In one example, see FIG. 5, the extension mechanism 15 can be coupled to the closure panel 14 on one side of the closure panel 14 as motorized biasing element 37, such that the lead screw 140 (see FIG. 6) is actively driven by a motor 136 assembly, and the extension mechanism 15 is incorporated at another side of the closure panel 14 in a differently configured biasing element 37, such that the second extension mechanism 15 is passively operated by motion of the closure panel 14 (e.g. as a counterbalance mechanism—see FIG. 4). In another embodiment as illustrated in FIG. 7c, the lead screw is a shaft 140′ that is operatively connected to the housing 40 (e.g. fixed to the housing 40, for example attached to an end wall 126 of the housing 40, a bushing 46 being positioned on a distal shaft portion 180′ (e.g. end) of the shaft 140′, such that lateral positioning (with respect to the longitudinal axis 41) of the shaft 140′ is facilitated by contact projections 200a,b,c,d maintaining contact with an interior surface 212 (of the shaft 53) while the shaft 53 extends and retracts (E-R) with respect to the housing member 40.

Recognizing the role of the bushing(s) 46, as the closure panel 14 moves between the open and closed positions, the torques (or forces) exerted the on the closure panel 14 by the biasing members 37 and by the weight of the closure panel 14 itself will vary. In one embodiment, the closure panel 14 can have some position between the open and closed positions at which the torque (or force) exerted on the closure panel 14 by the biasing members 37 cancels out the torque (or force) exerted on the closure panel 14 by the weight of the closure panel 14 (i.e. the torque or force of the biasing member(s) 37 acts against the weight of the closure panel 14). Above this point (which can be referred to as a balance point or otherwise referred to as the intermediate hold position), the torque (or force) exerted by the biasing members 37 can overcome the torque (or force) exerted by the weight of the panel 14 thus resulting in a net torque (or force) away from the closed position, thus biasing the closure panel 14 towards the open position (i.e. the torque or force of the biasing member(s) 37 acts against the weight of the closure panel 14). Below this point, the torque (or force) exerted by the weight of the panel 14 can overcome the torque (or force) exerted by the biasing members 37 thus resulting in a net torque (or force) towards the closed position, thus biasing the closure panel 14 towards the closed position. However, even in travel of the closure panel 14 towards the closed position, the torque or force of the biasing member(s) 37 acts against the weight of the closure panel 14. In this manner, the effect of the biasing member(s) 37 is to provide a torque or force that always acts against the weight of the closure panel 14 (i.e. always supplies a closing torque or force). It is recognized that “3rd position hold” can also be referred to as an “intermediate hold position” or a “stop and hold position”.

### Bushing 46 Examples

Referring to FIGS. 3a,b,c,d, shown are various embodiments of the bushing 46 connected (i.e. affixed) to an end of the shaft 53 of the extension mechanism 15 embodiment of FIG. 4 or to an end of the lead screw 140 of the extension mechanism 15 of FIG. 6. For convenience, the shaft 53 can be commonly referred to as an extension member 53. Further, the lead screw 140 and associated shaft 53 are positioned inside of housing member 40 of FIG. 6, while the shaft 53 is positioned inside of the housing member 40 of FIG. 4 (e.g. the extension member 35 is positioned at least partially inside depending on the length of the housing 40 and the telescoping overlap with the extension member 35 relative to the housing 40, for example depending on if the extension member is in an extended or retracted position relative to the housing 40). In FIG. 6, the bushing 46 is positioned on a distal screw portion 180 (e.g. end) of the lead screw 140, such that lateral positioning (with respect to the longitudinal axis 41) of the lead screw 140 is facilitated by contact projections 200a,b,c,d maintaining contact with an interior surface 212 (of the shaft 53) while the shaft 53 extends and retracts with respect to the housing member 40. While a plurality of projections 200 are illustrated forming a multiple point contact with the interior surface 212, the projection 200 may formed over the entire circumference of the bushing 46 establishing a continuous frictional contact or engagement with the interior surface 212. In FIG. 4, the bushing 46 is positioned on a proximal member portion 181 (e.g. end) of the shaft 53, such that lateral positioning (with respect to the longitudinal axis 41) of the shaft 53 is facilitated by contact projections 200a,b,c,d maintaining contact with the interior 50 of the housing member 40 while the shaft 53 extends and retracts with respect to the housing member 40. It is recognized that the projections 200a,b,c,d are in frictional contact with the inner or interior 50, to facilitate in hold operation of the extension mechanism 15 as described by example herein. It is further recognized that a plurality of bushings 46 can be positioned in the shaft 53 or lead screw 140, in order to customize the magnitude of frictional forces generated by contact of the projections 200a,b,c,d (collectively referred to as projections 200) as the extension mechanism 15 is operated during extension/retraction/hold of the shaft 53 with respect to the housing member 40. Please refer to FIGS. 7a and 7b for a cross sectional view of the extension mechanism 15 example embodiments, optionally as part of a biasing strut 37. In terms of the embodiment of the extension mechanism 15 shown in FIG. 4, the projections 200a,b,c,d are in frictional contact with the interior 50 of the housing member 40 and remain in continual frictional contact during reciprocation of the extension member 53 relative to the housing 40, which may include telescopic sliding and/or rotation of the extension member 53 relative to the housing 40.

FIG. 3a shows one embodiment of bushing 46a having a plurality (e.g. three or more) of contact projections 200a supported on (or otherwise integral to) a peripheral outer member 202a. For example, the projections 200a extend radially outward from the peripheral outer member 202a relative to an axis 210 of the bushing 46a (e.g. coincident with the longitudinal axis 41—see FIGS. 4, 6). The bushing 46a also has a peripheral inner member 204a spaced apart radially from the peripheral outer member 202a. The peripheral inner member 204a has a mount 206a (e.g. an aperture) for fixedly connecting (e.g. crimping) the bushing 46a to the end of the lead screw 140 (see FIG. 6) or the shaft 53 (see FIG. 4). It is envisioned that other connection types between the bushing 46a and the mount 206a, in general, and the lead screw 140 or shaft 53 can be provided other than shown, as desired, e.g. via adhesive, mechanical fasteners (rivets, screws, bolts, etc.), etc. The peripheral inner member 204a and the outer peripheral member 202a can be connected to one another by one or more connectors (e.g. webs) 205a which span the radial gap between the peripheral inner member 204a and the peripheral outer member 202a to provide for a reduction in weight and material costs of the bushing 46. For example, the peripheral inner member 204a, the peripheral outer member 202a, and the one or more connectors (e.g. webs) 205a can be formed of one or more pieces of the same/similar material (e.g. plastic, metal, etc.), for example as an integral one piece component.

The bushing 46a also has one or more (e.g. one respective for each projection 200a) resilient elements 208a (e.g. metal spring—collectively referred to as resilient element(s) 208) for biasing the projections 200a outwards from the axis 210 of the bushing 46a. For example, the resilient elements 208a can be metal tube springs 209 (e.g. see FIG. 3a), such that the diameter of the tubes can be expanded/compressed, thereby providing for the resilient nature (and bias provision thereof) of the resilient elements 208a. For example, the resilient elements 208a can be metal leaf springs 211 (e.g. see FIG. 3d), such that the curvature of the leaf spring 211 can be expanded/compressed, thereby providing for the resilient nature (and bias provision thereof) of the resilient elements 208a. For example, the resilient elements 208a can be metal ring springs 213 (e.g. see FIG. 3b, c), such that the curvature of the leaf spring 211 can be expanded/compressed, thereby providing for the resilient nature (and bias provision thereof) of the resilient elements 208a. For example, upon assembly of the bushing 46a within the extension mechanism 15, see further below, the outside peripheral wall 212a (being the interior surface 212 or the interior surface 50—shown in ghosted view) provided by the extension mechanism 15 can provide for a slight compressive force (e.g. friction fit) in order to precompress the projections 200a towards the axis 210. As such, during installation of the bushing 46a, the projection 200a of the peripheral outer member 202a and a body of the peripheral inner member 204a adjacent to the projection 200a are forced towards one another and thus compress the resilient element 208a. Once compressed, the resilient element 208a provides for a bias of the projections 200a away from the axis 210 and towards and into contact or engagement with the surface of the adjacent outside peripheral wall 212a. Therefore, as/if the projections 200a wear over time (i.e. become shorter projections extending from the peripheral outer member 202a), or otherwise the radial cross sectional spacing of the extension mechanism 15 with respect to the peripheral outer member 202a changes due to thermal expansion/contraction considerations (i.e. radial distance between the outside peripheral wall 212a and the axis 210 and/or radial distance between the peripheral outer member 202a and the axis 210 increases or decreases), the bias provided by the resilient elements 208a provides for maintaining of the contact between the projections 200a and the adjacent outside peripheral wall 212a.

In this manner, the desired positioning (e.g. centering) of the axis 210 of the bushing 46a (and the attached lead screw 140 or shaft 140′ or shaft 53) relative to the outside peripheral wall 212a is maintained, even in the event of designed wear and/or thermal expansion/contraction considerations experienced by the bushing 46a and/or extension mechanism 15 in general. For example, by providing the resilient elements 208a which may be illustratively formed of metal, a material less susceptible to changes in its resiliency or dimensions due to thermal expansion/contraction which may affect its biasing characteristics, the desired positioning (e.g. centering) of the axis 210 of the bushing 46a (and the attached lead screw 140 or shaft 53) relative to the outside peripheral wall 212a is maintained, even in the event of thermal expansion/contraction of the material forming the projections 200a, the peripheral outer member 202a and/or the peripheral inner member 204a which may be illustratively made from plastic or like material being more susceptible to dimensional and resiliency variations caused by thermal expansion/contraction caused changes in temperatures experienced by the vehicle 10. In accordance with an illustrative example, the resilient elements 208a may be a metallic spring element built, mounted, inserted, over molded, or integrated into the bushing 46a in order to provide a thermally stable normal force biasing the projection 200a surfaces outward toward the inner diameter of the outside peripheral wall 212a they are in contact with.

Referring to FIG. 3b, shown is a further example embodiment of the bushing 46b. In this embodiment, the bushing 46b has a plurality of projections 200b mounted on a peripheral outer member 202b (e.g. press fitted into receiving apertures formed in the peripheral outer member 202b). For example, the projections 200b extend radially outward from the peripheral outer member 202b relative to the axis 210 of the bushing 46b. The peripheral outer member 202b has an outside surface 203 for mounting the projections 200b thereon and an inner surface 207 (i.e. mount) for connecting (e.g. crimping) to the lead screw 140, shaft 140′ and/or the shaft 53 (see FIGS. 4 and 6). The projections 200b can be formed of a wearable material (e.g. plastic), while the peripheral outer member 202b can function as a resilient element (e.g. composed of metal acting as a metal spring). It is recognized that the projections 200b may extend radially inward from the peripheral inner member 202a relative to the axis 210 of the bushing 46b while the peripheral outer member 202b has an outside surface 203 for connecting (e.g. snap fit/press fit) to the housing 40 (e.g. to interior surface 50). The peripheral inner member 202a has an inside surface 201 for mounting the projections 200b thereon for frictionally engaging to the lead screw 140, shaft 140′ and/or the shaft 53 (e.g. see FIGS. 7a, 7b, 7c).

Similar to the bushing 46a, the bushing 46b also has the resilient element 208, in this case as the peripheral outer member 200b itself, for biasing the projections 200b outwards from the axis 210 of the bushing 46b. For example, upon assembly of the bushing 46b within the extension mechanism 15, see further below, the outside peripheral wall 212a (shown in ghosted view) provided by the extension mechanism 15 can provide for a slight compressive force (e.g. friction fit) in order to precompress the projections 200b towards the axis 210. As such, during installation of the bushing 46b, the projection 200b of the peripheral outer member 202b is forced towards the axis 210 and thus compress the peripheral outer member 202b also acting as the resilient element 208 in the vicinity of the projections 200b. Once compressed, the peripheral outer member 202b provides for a bias of the projections 200b away from the axis 210 and towards and into contact with the surface of the adjacent outside peripheral wall 212a.

Therefore, as/if the projections 200b wear over time (i.e. become shorter projections extending from the peripheral outer member 202b), or otherwise the radial cross sectional spacing of the extension mechanism 15 with respect to the peripheral outer member 202b changes due to thermal expansion/contraction considerations (i.e. radial distance between the outside peripheral wall 212a and the axis 210 and/or radial distance between the peripheral outer member 202b and the axis 210 increases or decreases), the bias provided by the peripheral outer member 202b provides for maintaining of the contact between the projections 200b and the adjacent outside peripheral wall 212a. In this manner, the desired positioning (e.g. centering) of the axis 210 of the bushing 46b (and the attached lead screw 140 or shaft 53) relative to the outside peripheral wall 212a is maintained, even in the event of designed wear and/or thermal expansion/contraction considerations experienced by the bushing 46b and/or extension mechanism 15 in general.

Referring to FIG. 3c, shown is a further embodiment of the bushing 46c In this embodiment, the bushing 46c has a plurality of projections 200c mounted on an peripheral outer member 202c. For example, the projections 200c extend radially outward from the peripheral outer member 202c relative to the axis 210 of the bushing 46c. The bushing 46c also has a peripheral inner member 204c spaced apart radially from the peripheral outer member 202c. The peripheral inner member 204c has a mount 206c (e.g. an aperture) for fixedly connecting (e.g. crimping) the bushing 46c to the end of the lead screw 140 (see FIG. 6) of shaft 140′ (see FIG. 7b) or the shaft 53 (see FIG. 4). It is envisioned that other connection types between the bushing 46c and the mount 206c, in general, and the lead screw 140 or shaft 53 can be provided other than shown, as desired, e.g. via adhesive, mechanical fasteners (rivets, screws, bolts, etc.), or by interference fit of the aperture over the outer surface of the lead screw 140, shaft 140′ or extension member 52, etc. The peripheral inner member 204c and the peripheral outer member 202c are adjacent to one another in the vicinity of the projections 200c and can be connected to or otherwise spaced apart from one another by one or more connectors (e.g. spacers) 205c which span the radial gap between the peripheral inner member 204c and the peripheral outer member 202c. For example, the projections 200c, the peripheral outer member 202c, and the one or more connectors (e.g. spacers) 205c can be formed of one or more pieces of the same/similar material (e.g. plastic, metal, etc.), for example as an integral one piece component. For example, the projections 200c and the peripheral outer member 202c, can be formed of one or more pieces of the same/similar material (e.g. plastic, metal, etc.) as an integral one piece component and the one or more connectors (e.g. spacers) 205c, can be formed as a separate component, or integrally formed with resilient element 208 as will be described herein below.

The projections 200c can be formed of a wearable material (e.g. plastic), while the peripheral inner member 204c can also function as a resilient element 208 (e.g. composed of metal acting as a metal spring). Similar to the bushing 46b, the bushing 46c also has a resilient element 208, in this case as the peripheral inner member 204c itself, for biasing the projections 200c outwards from the axis 210 of the bushing 46c. For example, upon assembly of the bushing 46c within the extension mechanism 15, see further below, the outside peripheral wall 212a (shown in ghosted view) provided by the extension mechanism 15 can provide for a slight compressive force (e.g. friction fit) in order to precompress the projections 200c towards the axis 210. As such, during installation of the bushing 46c, the projection 200c of the peripheral outer member 202c is forced towards the axis 210 and thus compresses the peripheral inner member 204c acting as the resilient element 208 in the vicinity of the projections 200c. Once compressed, the peripheral inner member 204c provides for a bias of the projections 200c away from the axis 210 and towards and into contact with the surface of the adjacent outside peripheral wall 212a. Therefore, as/if the projections 200c wear over time (i.e. become shorter projections extending from the peripheral outer member 202c), or otherwise the radial cross sectional spacing of the extension mechanism 15 with respect to the peripheral outer member 202c changes due to thermal expansion/contraction considerations (i.e. radial distance between the outside peripheral wall 212a and the axis 210 and/or radial distance between the peripheral outer member 202c and the axis 210 increases or decreases), the bias provided by the peripheral outer member 202c provides for maintaining of the contact between the projections 200c and the adjacent outside peripheral wall 212a. In this manner, the desired positioning (e.g. centering) of the axis 210 of the bushing 46c (and importantly the attached lead screw 140 or shaft 53) relative to the outside peripheral wall 212a is maintained, even in the event of designed wear and/or thermal expansion/contraction considerations experienced by the bushing 46c and/or extension mechanism 15 in general.

Referring to FIG. 3d, shown is a further embodiment of the bushing 46d having a plurality (e.g. three or more) of contact projections 200d supported on (or otherwise integral to) a peripheral outer member 202d. For example, the projections 200d extend radially outward from the peripheral outer member 202d relative to the axis 210 of the bushing 46d. The bushing 46d also has a peripheral inner member 204d spaced apart radially from the peripheral outer member 202d. The peripheral inner member 204d has a mount 206d (e.g. an aperture) for fixedly connecting (e.g. crimping) the bushing 46d to the end of the lead screw 140 (see FIG. 6) or the shaft 53 (see FIG. 4). It is envisioned that other connection types between the bushing 46d and the mount 206d, in general, and the lead screw 140 or shaft 53 can be provided other than shown, as desired, e.g. via adhesive, mechanical fasteners (rivets, screws, bolts, etc.), etc. The peripheral inner member 204d and the peripheral outer member 202d can be connected to one another by one or more connectors (e.g. webs) 205d which span the radial gap between the peripheral inner member 204d and the peripheral outer member 202d. For example, the peripheral inner member 204d, the peripheral outer member 202d, and the one or more connectors (e.g. webs) 205d can be formed of one or more pieces of the same/similar material (e.g. plastic, metal, etc.), for example as an integral one piece component.

The bushing 46d also has one or more (e.g. one respective for each projection 200a) resilient elements 208d (e.g. metal spring) for biasing the projections 200d outwards from the axis 210 of the bushing 46d. For example, the resilient element 208d can be a resilient metal peripheral element (e.g. ring either in whole or in pieces/parts coupled to or otherwise formed as part of the peripheral outer member 202d), such that a body (between the adjacent connectors 205d) of the resilient element 208d can be expanded/compressed outwards/inwards with respect to the axis 210, thereby providing for the resilient nature (and bias provision thereof) of the resilient element 208d. For example, upon assembly of the bushing 46d within the extension mechanism 15, see further below, the outside peripheral wall 212a (shown in ghosted view) provided by the extension mechanism 15 can provide for a slight compressive force (e.g. friction fit) in order to precompress the projections 200d towards the axis 210. As such, during installation of the bushing 46d, the projection 200d of the peripheral member outer 202d and one or more sections of the resilient element 208d adjacent to the projection 200d are forced radially inwards towards the axis 210 and thus compress the resilient element 208d. Once compressed, the resilient element 208d provides for a bias of the projections 200d away from the axis 210 and towards and into contact with the surface of the adjacent outside peripheral wall 212a. Therefore, as/if the projections 200d wear over time (i.e. become shorter projections extending from the peripheral outer member 202d), or otherwise the radial cross sectional spacing of the extension mechanism 15 with respect to the peripheral outer member 202d changes due to thermal expansion/contraction considerations (i.e. radial distance between the outside peripheral wall 212a and the axis 210 and/or radial distance between the peripheral outer member 202d and the axis 210 increases or decreases), the bias provided by the resilient elements 208d provides for maintaining of the contact between the projections 200d and the adjacent outside peripheral wall 212a. In this manner, the desired positioning (e.g. centering) of the axis 210 of the bushing 46d (and the attached lead screw 140 or shaft 53) relative to the outside peripheral wall 212a is maintained, even in the event of designed wear and/or thermal expansion/contraction considerations experienced by the bushing 46d and/or extension mechanism 15 in general.

In accordance with another embodiment, there is provided a bushing (46) for an extension mechanism (15) for coupling with a closure panel (14) of a vehicle (10) to assist in opening and closing of the closure panel, the extension mechanism including a housing member (40) defining a longitudinal axis (41), and an extension member (15) positioned at least partially in the housing member along the longitudinal axis, the extension member configured for extension and retraction with respect to the housing member. The bushing includes a peripheral outer member (202a) having an outside surface (203) for frictionally engaging with one of the housing and the extension member, a peripheral inner member (204a) spaced apart radially from the peripheral outer member and having an inner surface (203) for operably connecting with the other one of the housing and the extension member, and a one or more resilient elements (208) positioned between the peripheral outer member (202a) and the peripheral inner member (204a) for biasing the peripheral outer member (202a) away from the peripheral inner member (204a) to frictionally engage the outside surface (203) with the one of the housing and the extension member. In accordance with an embodiment, the one or more resilient elements are one or more resilient metallic elements. In an embodiment, the busing is sized (e.g. outer diameter) to be larger than inner diameter of the housing 40, or extension member 35, or generally the receiving tubular member in its unbiased and un-installed state, such that when inserted and assembled therein e.g. compressed, the bushing will impart a normal force on the housing 40, or extension member 35, or generally the receiving tubular member.

### Example Extension Mechanism 15 Configurations

The shaft 53 can be coupled (e.g. see FIG. 4) to the closure panel 14 (see FIG. 1) or the vehicle body 11 at a distal end and connected to the bushing 46 at a proximal end, thus providing for the relative motion of the bushing 46 along the axis 41 within the housing member (e.g. tube) 40. Alternatively, the bushing 46 can be connected to the lead screw 140 (e.g. FIG. 6) at one end, while having the travel member 45 rotating/translating about the axis 41 along the lead screw 140. It is recognized that the travel member 45 may not rotate on the lead screw 140, rather the travel member 45 can travels linearly along the longitudinal axis 41 and linearly along a body of the lead screw 140 as the lead screw 140 rotates about the longitudinal axis 41 and within a threaded bore 161. The bushing 46 is provided at the end of the lead screw 140 in order to maintain positioning/placement between the lead screw 140 and the housing member 40.

Referring to FIG. 4, shown is the biasing strut 37 example for housing the extension mechanism 15. The body 59 of the biasing strut is composed of a number of body elements 80 for facilitating extension and compression of the body 59 during operation of the closure panel 14 between the open and closed positions (see FIG. 1), thereby providing for the body 59 to act as a protective housing for the internal components (e.g. spring 68) of the biasing strut 37 and the enclosed extension mechanism 15. The body 59 can have the optional body elements 80 of a cover tube 82, a sliding tube 84, a sliding cover 86, a filler tube 88, and end covers 90. Internally, the spring 68 can be mounted between end caps 92 via optional spring seats 94. Also shown are a series of splines 100 on sliding tube 84 configured to cooperate with mating splines 102 on cover tube 82, thus providing for inhibiting of rotation between the component parts of the biasing strut 37 as the biasing strut is operated between the open and closed positions of the closure panel 14. Shown in FIG. 4 by example are further details of the housing member 40 coupled to the end 60 of the biasing strut 37 by an optional element 70 (e.g. fitting) and the shaft 53 coupled to the end 62 of the biasing strut 37 by an optional element 70. The first end 60 of the strut 37 can be for connecting to the closure panel 14 (or the vehicle body/frame 11) and the second end 62 for connecting to the vehicle body/frame 11 (or closure panel 14), depending upon the configuration orientation of the biasing element 37 when installed in the closure panel assembly 12 (see FIG. 1). It is recognized that one of the ends 60, 62 can be connected to the body 11 of the vehicle 10 and the other of the ends 60,62 can be connected to the closure panel 14, thus facilitating the opening and closing of the closure panel 14 with respect to the body 11. As mentioned, the interior surface 50 of the housing member 40 is in frictional contact with the projections 200a,b,c,d when the extension mechanism 15 is in operation.

Referring now to FIG. 6, an embodiment of the extension mechanism 15 for the motor vehicle 10 is shown. Electromechanical strut 37 as an example biasing member 37 includes a lower housing 112, an upper housing 114, and the extensible shaft/rod 53. A pivot mount 18, located at an end of lower housing 112 can be pivotally mounted to a portion of the vehicle body 11 that defines an interior cargo area in the vehicle 10. A second pivot mount 38 is attached to the distal end of extensible shaft 116, relative to upper housing 114, and is pivotally mounted to the lift gate 14 of the vehicle 10. The interior of lower housing 112 is shown in greater detail, by example. Lower housing 112 provides a cylindrical sidewall 122 defining a chamber 124. Pivot mount 18 is attached to an end wall 126 of lower housing 112 proximal to the vehicle body 11. Upper housing 114 provides a cylindrical housing member 40 defining a chamber 34 that is open at both ends. The (cylindrical) housing member 40 has the (peripheral) interior surface 50 spaced apart from the travel member 45. The shaft 53 has the interior surface 212 for engaging with the projections 200a,b,c,d (see FIGS. 3a,b,c,d) of the bushing 46a,b,c,d. A distal end wall 128 of lower housing 112 includes an aperture 130 so that chamber 124 and chamber 134 communicate with each other. Upper housing 114 can have a smaller diameter than lower housing 112. However, it is contemplated that lower housing 112 and upper housing 114 can also be formed as a single cylinder or frusto-cone. Other form factors for lower housing 112 and upper housing 114 will occur to those of skill in the art. Upper housing 114 can be integrally formed with lower housing 112, or it can be secured to lower housing 112 through conventional means (threaded couplings, weld joints, etc.). An optional motor-gear assembly 136 is seated in chamber 124 and can be an integral component of the electromechanical strut 37 (e.g. situated internally in the housings 112,114 as shown or alternatively situated external to the housings 112,114—not shown).

The optional motor-gear assembly 136 can include a motor 142, a clutch, a planetary gearbox, and the power screw 140 (or referred to as a lead screw 140) which can be used to transport or otherwise guide the travel member 45 along the longitudinal axis 41. Motor 142 can be mounted within chamber 124 near end wall 126. Motor 142 can be a direct current bi-directional motor. Electrical power and direction control for motor 142 can be provided via electrical cables that connect into the vehicle body 11 through apertures (not shown) in end wall 126. The clutch is connected to an output shaft on motor 142. Clutch can provide a selective engagement between the output shaft of motor 142 and the planetary gearbox. Clutch is an electromechanical tooth clutch that engages planetary gearbox when motor 142 is activated, for example. When clutch is engaged, torque is transferred from motor 142 through to planetary gearbox. When clutch is disengaged, torque is not transferred between motor 142 and planetary gearbox so that occurrence of back drive can be limited if the lift gate 14 is closed manually. For example, the planetary gearbox can be a two-stage planetary gear that provides torque multiplication for lead screw 140. Lead screw 140 extends into upper housing 114. As such it is recognized that in the case where the motor assembly 136 is present, the lead screw 140 can be driven, i.e. actively rotated by the rotary motion of the motor assembly 136 coupled to the lead screw 140. Alternatively, in the case where the motor assembly 136 is not present, the lead screw 140 can rotate about the longitudinal axis 41 under the influence of friction present between the travel member 45 and the lead screw 140 in the bore 161, i.e. passively rotated by the linear motion of the travel member 45 as it rotates about the lead screw 140.

Extensible shaft 53 provides a cylindrical sidewall 154 (having interior surface 212) defining a chamber 156 and can be concentrically mounted between upper housing 114 and power screw 140. As described earlier, pivot mount 38 is attached to the distal end of extensible shaft 53. The proximal end of extensible shaft 53 can be open. A nut 45 (also referred to as the travel member 45) is mounted at the proximal end of extensible shaft 53 relative to lower housing 112 and is coupled with lead screw 140 in order to convert the rotational movement of lead screw 140 into the linear motion of the extensible shaft 53 along the longitudinal axis 41 of lead screw 140. Drive nut 45 can include splines that extend into opposing coaxial slots provided on the inside of housing member 40 to inhibit nut 45 from rotating as the nut 45 travels along the longitudinal axis 41. Alternatively, the nut 45 may be configured without the splines and thus be free to rotate as the nut 45 travels along the longitudinal axis 41, without departing from the scope of the invention. An integrally-formed outer lip 164 in upper housing 114 can provide an environmental seal between chamber 134 and the outside.

A spring housing 138 is provided in lower housing 112 and is defined by cylindrical sidewall 122, end wall 128, and a flange 166. Within spring housing 138, a power spring 68 is coiled around lead screw 140, providing a mechanical counterbalance to the weight of the lift gate 14. Preferably formed from a strip of steel, power spring 68 assists in raising the lift gate 14 both in its powered and un-powered modes of the electromechanical strut 37. One end of power spring 68 attaches to lead screw 140 and the other is secured to a portion of cylindrical sidewall 122. When extensible shaft 53 is in its retracted position, power spring 68 is tightly coiled around lead screw 140. As lead screw 140 rotates to extend extensible shaft 53, in concert with travel of the travel member 45 along the housing member 40 (incurring contact of the projections 200a,b,c,d with the inner surface 212), power spring 68 uncoils, releasing its stored energy and transmitting an axial force through extensible shaft 53 to help raise the lift gate 14. When lead screw 140 rotates to retract extensible shaft 53, in concert with travel of the travel member 45 along the housing member 40 (incurring contact of the projections 200a,b,c,d with the interior surface 212), power spring 68 recharges by recoiling around lead screw 140.

As such, in view of the above, the extension mechanism 15 can be incorporated into a number of different biasing element 37 form factors. One example is the strut 37 without lead screw 140 (see FIG. 4, 7a), hence the bushing 46 only travels linearly along the longitudinal axis 41. Another example is the strut 37 with lead screw 140 (see FIG. 6, 7b), e.g. with or without the motor assembly 136, coupled to the travel member 45, hence the travel member 45 travels both linearly along the longitudinal axis 41 and rotationally about the longitudinal axis 41 (i.e. helical relative motion). Another example is the strut 37 with a shaft 140′ (see FIG. 7c), hence the bushing 46 (e.g. multiple bushings 46 are illustrated) is fixed to the shaft 140′ and therefore the housing 40 as the extension member 52 travels linearly along the longitudinal axis 41. It is also recognized that for the strut 37 of FIG. 6, the bushing 46 can be attached to the lead screw 140 such that the bushing 46 travels both linearly along the longitudinal axis 41 and rotationally about the longitudinal axis 41 (i.e. helical relative motion). Alternatively, for the strut 37 of FIG. 6, the bushing 46 can be attached to the lead screw 140 such that the bushing 46 travels only linearly along the longitudinal axis 41, such that rotational motion about the longitudinal axis 41 (i.e. helical relative motion) is restricted, e.g. by splines positioned on the interior surface 212 (for example to receive the projections 200a,b,c,d).

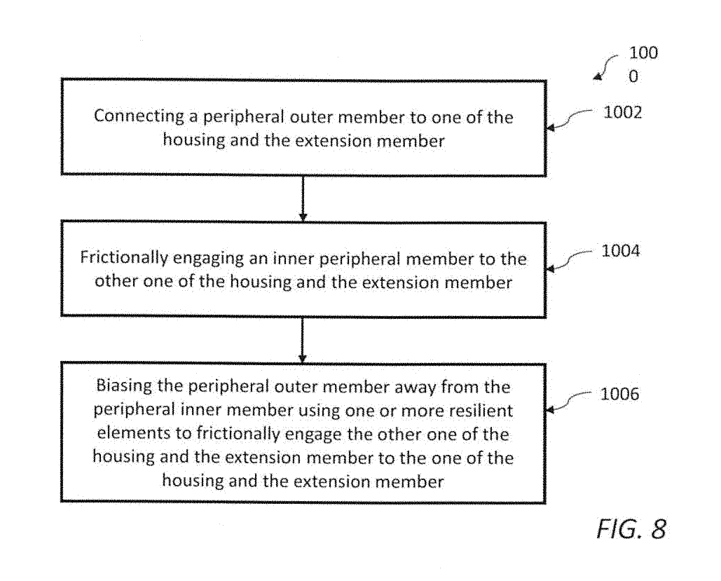

Now referring to FIG. 8, there is provided in accordance with an example a method of concentrically aligning a housing and an extension member of an extension mechanism 1000 for coupling with a closure panel of a vehicle to assist in opening and closing of the closure panel, the housing and the extension member configured to telescope relative to one another, the method 1000 including the steps of connecting a peripheral outer member to one of the housing and the extension member 1002, frictionally engaging an inner peripheral member spaced apart radially from the peripheral outer member to the other one of the housing and the extension member 1004 and biasing the peripheral outer member away from the peripheral inner member using one or more resilient elements, such as one or more resilient metallic elements, to frictionally engage the other one of the housing and the extension member 1006.

We claim:

1. An extension mechanism (15) for coupling with a closure panel (14) of a vehicle (10) to assist in opening and closing of the closure panel between a fully closed position and a fully open position of the closure panel, the extension mechanism including:
a housing member (40) having an interior (50);
a lead screw (140) positioned in the housing member along a longitudinal axis (41), the lead screw operatively coupled to a travel member (45);
an extension member (53) positioned in the housing member along the longitudinal axis and having an inner surface (212) between a distal member portion (182) and proximal member portion (181), the extension member connected to the travel member at the proximal member portion for assisting in extension and retraction of the extension member with respect to the housing member as the lead screw rotates; and
a bushing (46) connected to a distal screw portion (180) of the lead screw such that the bushing is positioned between the distal member portion and the proximal member portion, the bushing having one or more projections (200) extending laterally outwards with respect to the longitudinal axis and biased via one or more resilient elements (208) into frictional contact with the inner surface.

2. The extension mechanism of claim 1 further comprising the one or more projections mounted on a peripheral outer member (202) such that the one or more projections extend radially from an axis (210) of the bushing situated on the longitudinal axis.

3. The extension mechanism of claim 2 further comprising a peripheral inner member (204a) spaced apart radially from the peripheral outer member, the peripheral inner member connected to the peripheral outer member and having a mount 206a for connecting the bushing to the distal screw portion, such that the one or more resilient elements are compressed between the peripheral outer member and the peripheral inner member in order to bias the one or more projections radially outward from the axis.

4. The extension mechanism of claim 3 further comprising a plurality of connections (205a) between the peripheral inner member and the peripheral outer member between the one or more projections.

5. The extension mechanism of claim 2 further comprising the peripheral outer element acting as the one or more resilient elements, the peripheral outer member having an outside surface (203) for mounting the one or more projections thereon and an inner surface (207) for connecting the bushing to the distal screw portion.

6. The extension mechanism of claim 5, wherein the peripheral outer member is compressed towards the axis by the one or more projections acting on the inner surface in order to bias the one or more projections radially outward from the axis.

7. The extension mechanism of claim 2 further comprising a peripheral inner member (204c) spaced apart radially from the peripheral outer member, the peripheral inner member connected to the peripheral outer member and having a mount (206c) for connecting the bushing to the distal screw portion.

8. The extension mechanism of claim 7 further comprising the peripheral inner member acting as the one or more resilient elements, wherein the peripheral outer element is forced towards the axis by the one or more projections acting on the inner surface in order to compress the peripheral inner member also towards the axis in order to bias the one or more projections radially outward from the axis.

9. The extension mechanism of claim 8 further comprising a plurality of connections (205c) between the peripheral inner member and the peripheral outer member between the one or more projections.

10. The extension mechanism of claim 2, wherein the one or more resilient elements is a resilient peripheral element (208d) positioned adjacent to the peripheral outer member opposite to the peripheral inner member.

11. An extension mechanism (15) for coupling with a closure panel (14) of a vehicle (10) to assist in opening and closing of the closure panel between a fully closed position and a fully open position of the closure panel, the extension mechanism including:
a housing member (40) defining a longitudinal axis (41) and having an interior surface (50) between a distal housing portion (184) and a proximal housing portion (183);
an extension member (15) positioned in the housing member along the longitudinal axis, the extension member configured for extension and retraction with respect to the housing member; and
a bushing (46) connected to a proximal member portion (181) of the extension member such that the bushing is positioned between the distal housing portion and the proximal housing portion, the bushing having one or more projections (200a,b,c,d) extending laterally outwards with respect to the longitudinal axis and biased via one or more resilient elements (208) into frictional contact with the interior surface.

12. The extension mechanism of claim 11 further comprising the one or more projections mounted on a peripheral outer member (202) such that the one or more projections extend radially from an axis (210) of the bushing situated on the longitudinal axis.

13. The extension mechanism of claim 12 further comprising a peripheral inner member (204a) spaced apart radially from the peripheral outer member, the peripheral inner member connected to the peripheral outer member and having a mount 206a for connecting the bushing to the distal screw portion, such that the one or more resilient elements are compressed between the peripheral outer member and the peripheral inner member in order to bias the one or more projections radially outward from the axis.

14. The extension mechanism of claim 13 further comprising a plurality of connections (205a) between the peripheral inner member and the peripheral outer member between the one or more projections.

15. The extension mechanism of claim 12 further comprising the peripheral outer element acting as the one or more resilient elements, the peripheral outer member having an outside surface (203) for mounting the one or more projections thereon and an inner surface (207) for connecting the bushing to the distal screw portion.

16. The extension mechanism of claim 15, wherein the peripheral outer element is compressed towards the axis by the one or more projections acting on the interior surface in order to bias the one or more projections radially outward from the axis.

17. The extension mechanism of claim 12 further comprising a peripheral inner member (204c) spaced apart radially from the peripheral outer member, the peripheral inner member connected to the peripheral outer member and having a mount (206c) for connecting the bushing to the distal screw portion.

18. The extension mechanism of claim 17 further comprising the peripheral inner member acting as the one or more resilient elements, wherein the peripheral outer element is forced towards the axis by the one or more projections acting on the interior surface in order to compress the peripheral inner member also towards the axis in order to bias the one or more projections radially outward from the axis.

19. The extension mechanism of claim 18 further comprising a plurality of connections (205c) between the peripheral inner member and the peripheral outer member between the one or more projections.

20. A method of concentrically aligning a housing and an extension member of an extension mechanism for coupling with a closure panel of a vehicle to assist in opening and closing of the closure panel, the housing and the extension member configured to telescope relative to one another, the method comprising:
connecting a peripheral outer member to one of the housing and the extension member;
frictionally engaging an inner peripheral member spaced apart radially from the peripheral outer member to the other one of the housing and the extension member; and
biasing the peripheral outer member away from the peripheral inner member using one or more resilient metallic elements to frictionally engage the other one of the housing and the extension member.

21. The method of claim 20, further comprising the step of compressing the one or more resilient elements during the frictionally engaging the inner peripheral member to the other one of the housing and the extension member.
